(19) United States
(12) Patent Application Publication
(10) Pub. No.: US 2023/0118124 A1
(43) Pub. Date: Apr. 20, 2023

(54) DETECTION OF PERFORMANCE IRREGULARITIES WITHIN MULTI-ELEMENT VESSELS

(71) Applicant: DDP SPECIALTY ELECTRIC MATERIALS US, LLC., Wilmington, DE (US)

(72) Inventor: Steven Jons, Edina, MN (US)

(21) Appl. No.: 17/966,203

(22) Filed: Oct. 14, 2022

Related U.S. Application Data
(60) Provisional application No. 63/256,135, filed on Oct. 15, 2021.

(51) Int. Cl. C02F 1/00; C02F 1/44

(52) U.S. Cl. CPC C02F 1/004; C02F 1/444; C02F 2209/445

(57) ABSTRACT

Filtration vessels containing multiple filtration elements, and devices and processes for detection of leaks within these filtration elements.

### CROSS REFERENCE TO RELATED APPLICATIONS

This application is a U.S. Non-Provisional application that claims the benefit of priority of U.S. Provisional application No. 63/256,135 filed on Oct. 15, 2021, which is incorporated by reference in its entirety.

### FIELD OF INVENTION

This invention relates to filtration vessels containing multiple filtration elements, and the devices and processes for detection of leaks within these filtration elements.

Microfiltration (MF) and Ultrafiltration (UF) elements are commonly employed within a pressure vessel. Through the application of pressure to one surface of the membrane, the semi-permeable membrane is able to separate a feed fluid into a treated permeate stream that passes through the membrane and a retentate stream that does not. A common element design comprises a plurality of hollow fiber membranes that are potted on two ends, at least of the two ends cut to expose the open lumens of each hollow fiber. In some cases, only one end of the hollow fiber is potted and then exposed by trimming, the other end of the hollow fiber being sealed and freely movable.

Other common element designs use a looped bundle of hollow fibers, having both ends of hollow fiber membranes within the same potted surface and exposed. In still other filtration elements, flat sheet membranes may be arranged in parallel and employed as cassettes or membrane sheets may be rolled into a spiral wound element. All of these element geometries can enable a feed stream to be separated into a permeate stream and a retentate stream.

Pressure vessels that contain multiple filtration elements can also be used to treat large volumes of liquid. In some embodiments, several semi-permeable membrane elements may be mounted vertically in a sealed vessel. Feed solution is fed into individual elements within the vessel, and the feed is separated under pressure by their respective membranes into a concentrate stream and a permeate stream. Streams from different elements are typically combined, with the permeate and concentrate streams separately leaving the vessel.

A multi-element vessel can reduce capital cost and footprint. However, as compared to a similar number of elements within their own separate vessels, multi-element vessels can provide issues in detection of irregularities in flow and integrity from individual elements. One reason for this is that the relative impact of performance issues is less on the combined stream than it would be if the same defect were present for a single isolated element. For instance, small gas bubbles from a single compromised fiber would be located within a much larger volume of water that leaves the multi-element vessel, making it more difficult to observe. The dilution effect is similar for flow irregularities from a single filtration element.

### SUMMARY OF THE INVENTION

The present invention is directed to a water filtration system comprising:
a pressure vessel;
a pressure plate within the vessel that separates a high-pressure feed chamber from a low-pressure permeate chamber, said pressure plate has a plurality of through holes therethrough;
a plurality of parallel filtration elements located within the feed chamber, each of said filtration elements having a feed inlet, a waste outlet, and a permeate outlet;
a plurality of filtration element end adapters, each end adapter attached to one of said plurality of filtration elements and to the pressure plate, such that the end adapter creates a sealed flow path between the permeate outlet of the attached filtration element and a flow path egress for discharging into the permeate chamber of the vessel, said flow path passing through one of said plurality of pressure plate through holes and said flow path egress consisting of at least one aperture adjacent the permeate chamber;
a plurality of bubble release zones within the permeate chamber, each zone corresponding to a single filtration element and being defined as the volume within the permeate chamber of a cylinder which is located adjacent to the flow path egress for said single filtration element, and whose radius is the distance from the center of the aperture to the furthest point from which permeate leaves the aperture and whose length is 5 cm in an axial direction from the aperture;
a light source positioned to provide illumination within the permeate chamber; and
a first camera positioned to image multiple bubble release zones selected from said plurality of bubble release zones.

### BRIEF DESCRIPTION OF DRAWINGS

The invention and various embodiments may be better understood by reference to the description and accompanying figures. In the figures, like reference numerals refer to like elements. Figures are provided to facilitate description and are not necessarily to scale.

FIG. 1 is a cross section of a first embodiment showing multiple elements and cameras within a vessel.

FIG. 2 is a cross section of a second embodiment, the embodiment showing multiple elements, multiple lights, and a camera within the vessel.

FIGS. 3-5 illustrate different embodiments having distinct bubble release zone configurations resulting from different components and paths for permeate flow.

FIG. 6 is a cross section through the permeate chamber of a vessel containing 99 elements.

### DETAILED DESCRIPTION OF INVENTION

This invention is a water filtration system and method for its use that includes a vessel, multiple filtration elements within the vessel, and an image-based monitoring system suitable to identify the origin of bubbles and assess if filtration elements within the vessel have substantial leaks.

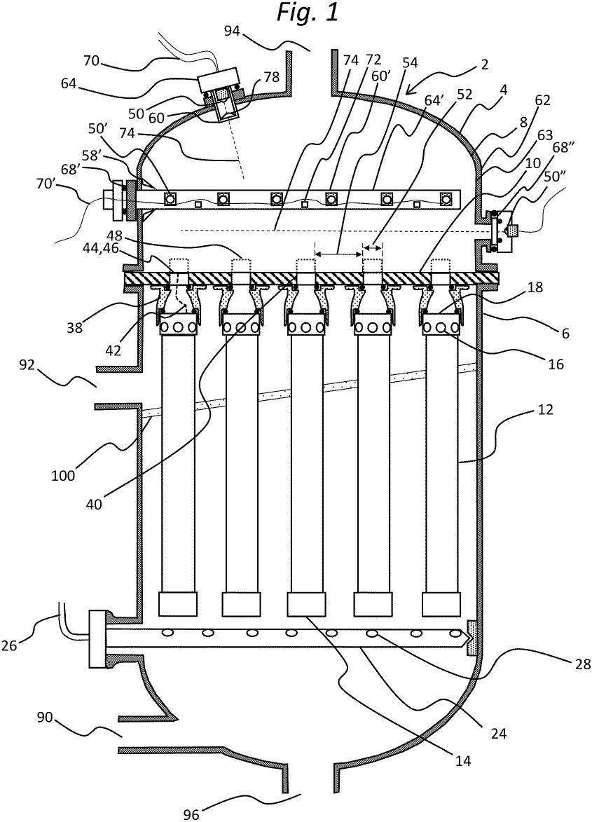

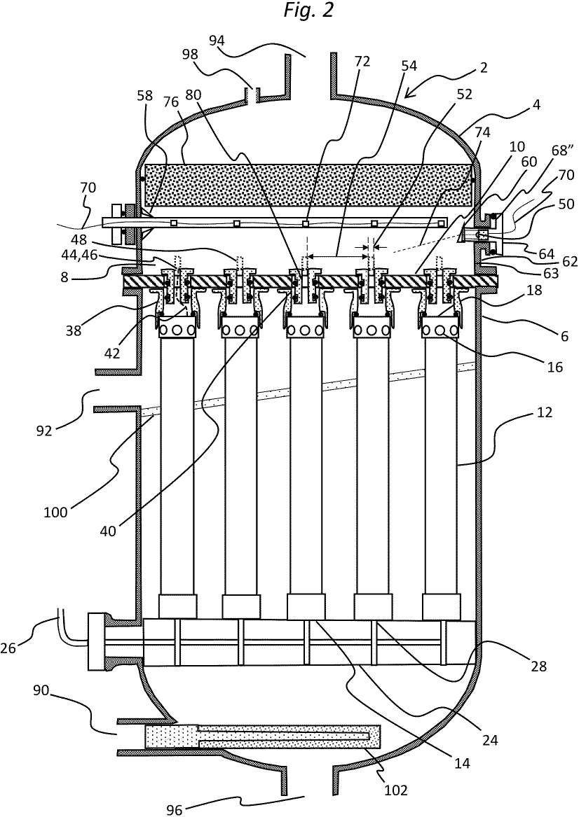

The water filtration system 2 includes a pressure vessel 4, which preferably has a cylindrical cross section. Referring to FIGS. 1 and 2, the pressure vessel 4 contains several required and optional ports. Fluid to be treated is provided to the pressure vessel through a feed input port 90. This fluid to be treated may also pass through a prefilter 102, as illustrated in FIG. 2. Fluid rejected by the filtration elements 12 is purged via a concentrate output port 92. Both FIGS. 1 and 2 illustrate an optional canted plate 100 within the vessel 4 to assist in directing rejected fluid to the concentrate output port 92 and hinder it settling below. A treated permeate stream is removed from the vessel 4 through a permeate output port 94. An optional drain port 96 provides a means to remove settled material. An optional air bleed port 98 facilitates removal of air from the permeate chamber, which may be desired when starting up. An air distributor 24 attached to a source of pressurized gas 26 can periodically provide air bubbles to shake up and clean the filtration elements 12, as well as induce an upward flow of the fluid to be treated within elements. FIG. 1 illustrates a removable air distributor that can be extended into and retracted from the vessel through a port. The air distributor of FIG. 2 provides common paths for introducing to the element both air and the feed water to be treated. In practice, several types of air distributors are known.

The pressure vessel further 4 includes a feed chamber 6 and a permeate chamber 8, and these two chambers are separated by a pressure plate 10. In operation, the feed chamber 6 is usually at a higher pressure than the permeate chamber 8. The pressure vessel 4 is preferably oriented vertically and the pressure plate 10 is preferably oriented horizontally, with the permeate chamber 8 above the feed chamber 6. (Within this document, it is understood that “parallel”, “vertical”, and “horizontal” indicate only approximate orientations. Parallel elements 12 are intended to describe elements having an axis within 15 degrees of each other. Similarly, horizontally- and vertically-oriented objects are within 15 degrees of the true horizontal plane and vertical vector defined by gravity.)

The high-pressure feed chamber 6 contains a plurality of parallel filtration elements 12. Each filtration element 12 has a feed inlet 14, a waste outlet 16, and a permeate outlet 18. The feed inlet 14 and waste outlet 16 are fluidly connected within the filtration element 12. Beyond the connecting flow regions within the element 12, the two locations (14, 16) may be isolated outside the element 12 or they may be fluidly connected. In a preferred embodiment, the waste outlet 16 may be located above the feed inlet 14, and air bubbles 22 can be introduced from below on the feed side of the filtration element 12 to encourage an upward flow of feed water within the filtration element 12. Preferably, an air distributor 24 is connected to a source of pressurized air 26 and includes distribution holes 28 located below the elements 12 in the vessel 4.

Each filtration element 12 can include one or more porous membranes. Membrane materials useful for this invention are not particularly limited but may include several polymers frequently employed for ultrafiltration or microfiltration: polyvinylidene fluoride (PVDF), polysulphone (PS), polyethersulphone (PES), polyacrylonitrile (PAN), polyethylene (PE), polypropylene (PP), cellulose acetate (CA), and blends of polymers containing these. The geometry for membranes within the filtration element 12 may be flat sheet or hollow fiber. Filtration elements 12 that incorporate flat sheet membranes can be in a cassette or spiral wound configuration. Hollow fiber elements 12 may be constructed to operate as either as outside-to-inside or as inside-to-outside fibers.

For each filtration element 12, the permeate outlet 16 is separated from the feed inlet 14 and waste outlet 16 by at least one membrane. However, it is preferred that many individual membranes separate the permeate outlet 16 from the feed inlet 14 and waste outlet 16. In preferred embodiments, filtration elements 12 within the vessel 4 contain a plurality of hollow fiber membranes, and the permeate outlet 16 is in fluid contact with the inner lumens of those hollow fiber membranes (i.e. an outside-to-inside configuration). At the same time, the feed inlet 14 is in fluid contact with the outer surfaces of those same hollow fiber membranes.

Vertically oriented hollow fiber filtration elements 12 may be potted on one or both ends, and permeate may also be withdrawn from one or both ends. In preferred embodiments, hollow fibers extend to the upper tube sheet (potting layer) 36, with their lumens exposed. In operation, permeate passes through the lumens and across the upper tube sheet 36 to the permeate outlet 16.

The permeate outlet 16 of each filtration element 12 is attached to an end adapter 38. This attachment may be permanent or reversible, but the latter is preferred so that a broken fiber may be accessed at the tube sheet 36 and pinned/sealed. In one embodiment, the end adapter 38 is screwed to threads outside the element 12, squeezing an o-ring seal that prevents leaks between the two pieces. (In that embodiment, the reversible attachment allows the end adapter 38 to be removed from the element 12 and facilitates access to the filtration element’s tube sheet 36 and the open ends of hollow fibers.)

The end adapter 38 is also attached and sealed to the pressure plate 10. The pressure plate 10 contains through holes 40 between the feed chamber 6 and permeate chamber 8, and these through holes 40 enable a sealed flow path 42 between each filtration element 12 and the permeate chamber 8. In preferred embodiments, pressure plate through holes 40 have a 1:1 corresponds to individual filtration elements 12. However, an individual element 12 may also be connected to the permeate chamber 8 through multiple through holes 40 in the pressure plate 10. For this invention, it is not preferred for permeate from multiple filtration elements to pass through the same through hole in the pressure plate.

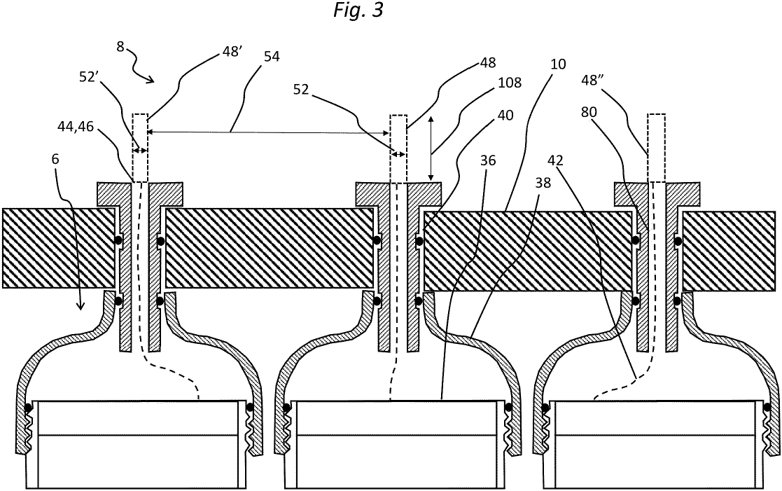

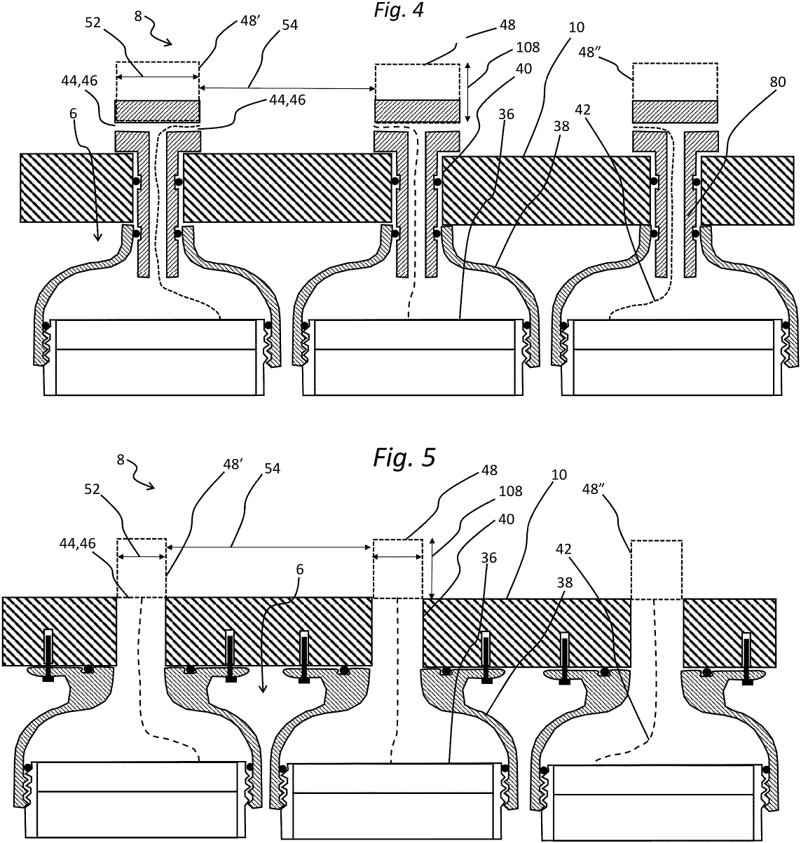

Each end adapter 38 creates a sealed flow path 42 between the permeate outlet 16 of the attached filtration element 12 and an egress 44 for discharging permeate into the permeate chamber 8 of the vessel 4. The egress 44 marks the end of the flow path 42 and consists of at least one aperture 46 adjacent the permeate chamber 8. The aperture(s) 46 may be vertical or horizontal or something therebetween. In FIG. 3., the flow path 42 includes a conduit 80 that passes through the through hole 40 in the pressure plate 10 and is sealed to the end adapter 38. A horizontal aperture 46 at the upper end of the conduit 80 is adjacent the permeate chamber 8 and is the egress 44 for fluid flow into the permeate chamber 8. In a related embodiment (FIG. 4), the egress 44 consists of multiple vertical apertures 46 that are adjacent the permeate chamber 8, in this case resulting in a bubble release region having a larger span across it than in FIG. 3. In FIG. 5., an end adapter 38 is attached and sealed to the lower surface of the pressure plate 10. In this case, the egress 44 is an aperture 46 at the top of the through hole 40, adjacent the permeate chamber 8.

In typical operation, permeate fluid passes through the sealed flow path 42 between the permeate outlet 16 and an egress 44 for discharging permeate into the permeate chamber 8. In some cases, such as during an air-pressurized leak test, gas can be introduced into the permeate side of the element 12. Air bubbles from a broken fiber may pass from the permeate outlet 16 of one filtration element 12 to the corresponding aperture(s) adjacent the permeate chamber 8. Passing through these apertures 46, they enter the permeate chamber 8.

A plurality of bubble release zones 48 may be defined within the permeate chamber 8. Bubbles have a tendency to rise in water, but the actual travel paths for bubbles (which may be approximated by numerical simulations) will depend on parameters that include the egress 44 geometry, flow from nearby elements 12, and the exact initial positions and velocities of bubbles passing through the egress 44. For purposes of this application, a bubble release zone 48 corresponding to a single filtration element 12 is defined as the volume within the permeate chamber 8 of a cylinder that is located directly “above” and within 5 cm of the flow path egress 44 for that single filtration element 12. The radius of the cylindrical volume is the radius of the egress aperture 46, defined by the furthest radial position from the center of the aperture from which permeate leaves the element. The length of the cylinder is 5 cm from the egress in an axial direction, i.,e. vertically if the elements are vertical. This definition is independent of operating conditions. In FIGS. 3-5, the bubble release zones are illustrated for different configuration, limited in volume by the specific 5 cm height 108.

Preferably, there are a plurality of bubble release zones 48 within the permeate chamber 8, each zone 48 corresponding to a single filtration element 12. However, these bubble release zones 48 preferably cover a small fraction of the vessel cross section, so that it is easier for images from one or more cameras 50 to be used in identifying the source of a leaking fiber. In one embodiment, a first camera 50 can be positioned to image multiple bubble release zones 48 selected from the plurality of bubble release zones 48 within the permeate chamber 8. Preferably, each of these multiple bubble release zones 48 has a diameter 52 of the associated cylinder which is shorter than the separation distance 54 between any two of said multiple bubble release zones 48. A flow path egress 44 that results in a relatively small bubble release zone 48 makes it easier to identify the source of bubbles among many filtration elements 12 in a crowded vessel.

In another preferred embodiment, each through hole 40 in the pressure plate 10 is small compared to the size of the corresponding filtration element 12. This supports localizing the region utilized for passing bubbles, so that bubbles may be observed easier when imaging and be more easily attributed to specific filtration elements 12 — despite a potentially large number of bubble release zones 48 within the field of view 56 for a camera 50 In preferred embodiments, the cross-sectional area of each filtration element 12 is at least five times larger, more preferably at least ten times larger, than the cross-sectional area of a corresponding through hole 40 in the pressure plate 10.

In this invention, a large number of filtration elements 12 may be arranged within the pressure vessel 4. In preferred embodiments, there may be more than 50 filtration elements 12 within the vessel 4, and these may be tightly packed. More preferably, there may be more than 90 filtration elements 12 within the vessel 4, and the inner diameter of the vessel 4 may greater than 175 cm. In some preferred embodiments, the maximum outer diameter of filtration elements 12 is between 8% and 12% of the vessel’s inner diameter. Despite the large number of potentially tightly arranged filtration elements 12, preferred camera arrangements would be suitable to identify bubble streams that indicate leaks. A single camera 50 may image all or a subset of the bubble release zones 48 corresponding to filtration elements 12 within the vessel 4. For this purpose, one or more cameras (see camera 50 in FIG. 1.) near the top of the vessel 4 can most easily provide a clear view of the different bubble release zones 48 and distinguish between those from different filtration elements 12.

The location and configuration of a first camera 50 enables it to image multiple bubble release zones 48 within the permeate chamber 8. However, in preferred embodiments, it may still be required to have one or more additional cameras 50 to image all of the bubble release zones 48 that correspond to filtration elements 12 within the vessel 4. Further, several bubble release zones 48 may be imaged by the multiple cameras 50, and detection/identification of leaks may be best done by providing data from different cameras 50 to a common microprocessor (not shown). In this preferred embodiment, the different angles from which scattered light is observed by two or more different cameras 50 can be used to determine the location of bubbles. Locations may be directly calculated by triangulation and a leak ascribed to the proximate filtration element 12, or the process may be abstracted through machine learning or the use of lookup tables from observed angles of different cameras 50. In one approach, a response function that indicates the likelihood of a leak for each filtration element 12 is calculated based on weighted responses derived from the different pixels of the multiple cameras 50 observing bubble release zones 48. (Responses derived from the different pixels may relate to the average intensity of light hitting the sensor at the point, but it may alternatively relate to the variation in the intensity of light hitting at that point, or other functions that quantify a rapid change in light scatter.)

A digital camera may include the sensor (e.g. CCD, CMOS), optics (e.g. lenses, mirrors, filters), electronics, and cables, as well as various other components (lights, memory, battery). These components may be packaged together or be physically separated, and cameras 50 may interface with parts (e.g. microprocessor) shared by other cameras 50. Consequently, for purposes of this invention, a “camera” is considered to be a digital camera and the “camera” location is considered to be the location of the sensor, which may be considered the heart of a digital camera. In several preferred embodiments, imaging is performed through a transparent isolating optical component 60 (e.g. window, lens, prism) that contacts the permeated liquid and prevents electronics from contacting the liquid. In preferred embodiments, the transparent isolating optical component 60 is located within the vessel 4. In some embodiments, it is also located within the permeate chamber 8. One or more cameras (camera sensors) or optics may also be located within vessel 4 or the permeate chamber 8. When there are protrusions into or extensions from the vessel 4, an object is considered to be located within the vessel 4 based on its relative position compared to an extension of the outer surface 62 of the vessel 4. Similarly, an object is considered to be located within the permeate chamber 8 based on its relative position compared to an extension of the inner surface 63 of the vessel 4. For instance, as illustrated in FIG. 2, the camera 50 is within the vessel 4 but not the permeate chamber 8. The transparent isolating optical component 60 on the same mount 64 is illustrated as a prism and it is within both the vessel 4 and the chamber 8, as it is located internal of the surrounding inner surface 63 of the vessel wall. When the transparent isolating optical component 60 is a lens or prism, light can be bent or focused to provide a modified sight line 74 and field of view 56 within the permeate chamber 8.

A camera 50 and associated transparent isolating optical component 60 may both attached to a mount 64 that extends into said permeate chamber 8 through a port 66 on the vessel 4. The mount 64 is preferably removable from the vessel 4 through a port 66, and this would enable the transparent isolating optical component 60 to be removed and cleaned without substantial disassembly of parts within the vessel 4. Preferably, the port 66 is relatively small, having an inner dimension which would prevent removal of filtration elements 12 through the port 66. More preferably, the limiting inner dimension of the port 66 is less than 20 cm, more preferably less than 10 cm or 5 cm, or even less than 2 cm. The port 66 may include a movable restricting means 58, such as a flap, spring-loaded obstruction, or compliant orifice, so that the mount 64 may be inserted within the port 66 but the restricting means 58 moves to retard water within the vessel 4 from leaving through the port 66 when the mount 64 is pulled from the vessel 4.

Multiple cameras 50 may be located within the permeate chamber 8 of the vessel 4. These multiple cameras 50 may be attached to separate mounts 64 or to a common mount 64 that passes through a port 66. In some embodiments, multiple mounts 64 may each support multiple cameras 50 located within the vessel 4. A mount 64 preferably further supports at least one transparent isolating optical component 60 that extends within the vessel 4 during operation and that can be extracted through the port 66 for cleaning or maintenance. A mount 64 also preferably includes a seal surface 68 suitable to create a water-tight seal with the vessel 4. The water-tight seal between the mount 64 and vessel 4 combine with one or more transparent isolating optical components 60 to isolate multiple cameras from fluid within the permeate chamber 8. In a preferred embodiment, multiple cameras are located within two element diameters of the vessel wall, and, more preferably, multiple cameras are located within one element diameter of the vessel wall.

It is possible that cameras 50 located within the pressure vessel 4 may wirelessly transmit data outside the vessel 4, and this may be facilitated by a region between the camera 50 and vessel wall from which water is excluded, so that electromagnetic signal is more easily transmitted. Wireless transmission may also be facilitated by lower frequency signals that are less attenuated by conductive water. In other preferred embodiments, wires 70 for power and signal are transferred out of the vessel through a port 66. Most preferably, a port 66 provides access for a mount 64, at least one camera 50 attached the mount 64, at least one transparent isolating optical component 60 separating the attached camera(s) from the permeate fluid, and wires 70 for providing power to the camera(s) and transmitting data from the camera(s).

To assist in imaging bubble release zones 48 with one or more cameras 50, an appropriate light source 72 can be positioned to provide illumination within the permeate chamber 8. One or more light sources (preferably LEDs) 72 may be attached to a mount 64. The mount may also supports at least one camera 50. A transparent isolating optical component 60 may prevent both the camera 50 and light sources 72 from contacting permeate fluid from the permeate chamber 8. Preferably, the light source 72 and camera 50 do not employ other common optics. More preferably, the camera 50 and light source 72 do not employ any common optics. In one preferred embodiment, multiple light sources 72 within the system 2 are independently controllable so that different bubble release zones 48 may be preferentially illuminated at different times. In a more preferred embodiment, the multiple light sources 72 are attached to a mount 64 that extends within the vessel 4 and may be removable through a port 66.

A camera 50 which is located near the top of the vessel 4 may provide a predominantly vertically sight line 74 that facilitates identifying the source of bubbles from a plurality of horizontally separated bubble release zones 48. However, in some case, it may be preferred to situate one or more cameras 50 that provide a predominantly horizontal sight line 74 across a plurality of horizontally separated bubble release zones 48. In one embodiment, one or more cameras 50 may be attached to a mount 64 that is sealed to a port 66 on the side of the vessel 4. Providing a predominantly horizontal sight line 74 may be useful when attempting to also obtain information on flow patterns and/or flow velocity from individual filtration elements 12, such as by tracking individual bubbles with a vertical component or by monitoring the vertical displacement of objects moved by the force of permeate fluid. In another advantageous case for providing a predominantly horizontal sight line 74, a section of the vessel 4 above the permeate chamber 8 may include an additional separation device 76 above the pressure plate 10 that would restrict a view from the top. Such an additional separation device 76 could incorporate additional ultrafiltration membrane, a reverse osmosis element 12, ion-exchange beads, or a biological contactor suitable to consume nutrients within the permeated water. When one or more cameras 50 are oriented to provide a predominantly horizontal sight line 74 across a plurality of horizontally-oriented bubble release zones 48, it is particularly useful for the system to have relatively confined bubble release zones 48 having a small diameter 52, so that multiple bubble release zones 48 can be distinguished. For purposes of this invention, a site line 74 corresponds to the line in object space (at approximately the distance from the camera of bubble release zones) that is mapped to the center pixels of a camera’s sensor. A predominantly vertical sight line 74 is considered to be centered within 30 degrees of the vertical axis, and a predominantly horizontal sight line 74 is considered to be centered within 30 degrees of horizontal.

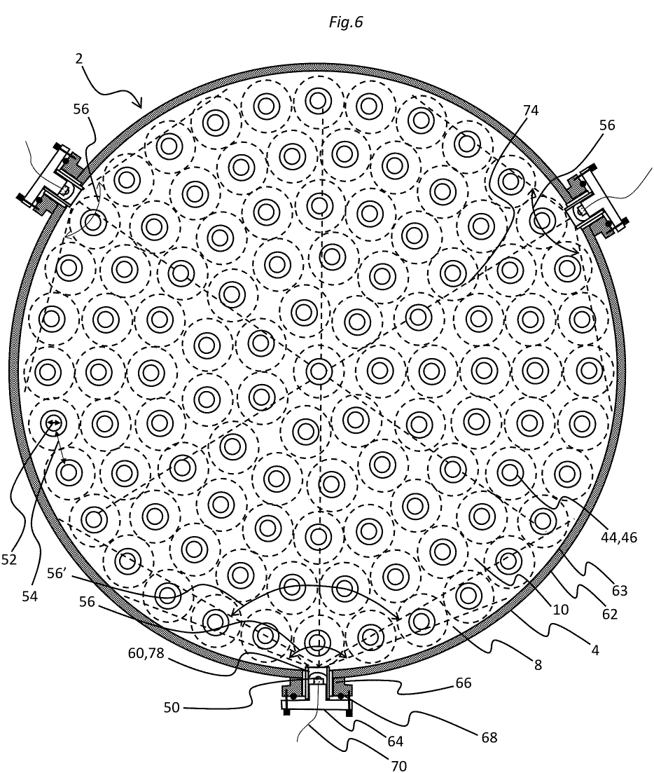

FIG. 6 shows a horizontal cross section of the vessel 4 across a region of the permeate chamber, with 99 elements tightly packed in the vessel, each having a central circle designating the permeate flow egress 44. (For reference, dashed circles illustrate the associated outer diameters of each element, although it is envisioned that the larger diameter element bodies would typically be located below the pressure plate and in a different plane than the egress 44 for permeate flow.) For each of the three cameras 50, straight dashed lines are used to illustrate both the horizontal sight line 74 and the opposing boundaries of a 140 degree angular field of view 56. For one camera, two opposing boundary lines for a smaller 120 degree field of view 56′ are also shown for one camera.

In some embodiments, the system includes a lens 78 that provides more than a 120 degree angular field of view 56 for the camera 50 within a horizontal plane. More preferably, the angular field of view for the camera is more than 130 degrees, more than 140 degrees, or even more than 145 degrees. Lenses 78 between the camera 50 and imaged object may all be symmetric or at least one may be asymmetric, such that it has different focal lengths in horizontal and vertical directions. The angular field of view can also be influenced by the size of a sensor in its two mutually perpendicular directions.

When a camera 50 is oriented to provide a predominately horizontal sight line 74, optics may preferably be employed between the camera sensor and bubble release zones 48 to result in a field of view 56 that is at least 4 times wider than it is tall. Along the predominant site line 74 (the imaged region corresponding to the center location of camera sensor), the resolution is preferably at least 4 times greater, more preferably 10 times greater, in the vertical direction than it is in the horizontal direction. This enables finer displacements in the vertical direction to be observed, as compared to in the horizontal direction. One way this may be accomplished is to employ a cylindrical lens or plano-cylindrical oriented such that parallel light rays are focused in the vertical direction, but not appreciably defracted in the horizontal direction. In preferred embodiments, a lens 78 with increased focusing power in the vertical direction, as compared to the horizontal direction, is provided in front of the camera 50. This lens 78 may be optically coupled to the camera. This lens 78 may also be coupled to or serve as the transparent isolating optical component 60 that contacts liquid within the permeate chamber 8 and prevents the camera’s electronics from contacting the liquid.

To image a bubble release zone 48 does not mean that all parts of the bubble release zone 48 need be observable. Obtrusions, such as the upper end of the vertical conduit in FIG. 4, may block a part of the view from a specific camera. However, it is preferred that a camera 50 which images a bubble release zone 48 is positioned suitable to observe the majority of that particular zone 48.

Data from one or more cameras 50 may take different forms. It may be in the form of a picture or movie. However, with some methods of analysis (e.g. when based on machine learning), it is also reasonable that data corresponding to only parts of an image is required or that a mathematically manipulated subset of available data is used. Also, required data might be analyzed in real time or assessed subsequently with the additional input of different devices. The process of imaging a part of the system (e.g. a bubble release zone 48) includes both acquiring a response of the camera sensor and providing data derived from the response to a processor external to the vessel 4.

In a preferred method of identifying broken fibers, a multi-element vessel 4 with bubble release zones 48 is provided, as described in one of the previous embodiments with multiple cameras 50. The feed water is substantially drained from the feed chamber 6 of the vessel 4 and the feed chamber 6 is instead pressurized with low-pressure air. Preferably, feed-side air pressure is less than 5 bar and more than 0.5 bar. More preferably, it is between 1 bar and 2.5 bar. With air pressure applied on the feed side of membranes, a plurality of cameras 50 together image all of the bubble release zones 48 corresponding to filtration elements 12 within the vessel 4, no single camera 50 images all of the bubble release zones 48, and multiple bubble release zones 48 are imaged by more than one of the plurality of cameras 50. Data from the plurality of cameras 50 is provided to a common microprocessor. The microprocessor provides an output that indicates whether different filtration elements 12 within the vessel 4 have a high probability for broken fibers or other leaks. Suitable output from the microprocessor may be, for example, a warning light trigger, sound alarm, an email, text message, or monitor display change.

In another preferred method for identifying broken fibers, a multi-element vessel 4 with bubble release zones 48 is provided, as described in one of the previous embodiments with at least one camera 50 that is attached to a mount 64 which extends into the permeate chamber 8 through a port 66 on the vessel 4. The method includes removing the mount 64 from the camera 50 through the port 66, cleaning the camera, and re-inserting the mount 64.

1. A water filtration system comprising:
a pressure vessel;
a pressure plate within the vessel that separates a high-pressure feed chamber from a low-pressure permeate chamber, said pressure plate has a plurality of through holes;
a plurality of parallel filtration elements located within the feed chamber, each of said filtration elements having a feed inlet, a waste outlet, and a permeate outlet;
a plurality of filtration element end adapters, each end adapter attached to one of said plurality of filtration elements and to the pressure plate, such that the end adapter creates a sealed flow path between the permeate outlet of the attached filtration element and a flow path egress for discharging into the permeate chamber of the vessel, said flow path passing through one of said plurality of pressure plate through holes and said flow path egress consisting of at least one aperture adjacent the permeate chamber;
a plurality of bubble release zones within the permeate chamber, each zone corresponding to a single filtration element and being defined as the volume within the permeate chamber of a cylinder which is located adjacent to the flow path egress for said single filtration element, and whose radius is the distance from the center of the aperture to the furthest point from which permeate leaves the aperture and whose length is 5 cm in an axial direction from the aperture;
a light source positioned to provide illumination within the permeate chamber; and
a first camera positioned to image multiple bubble release zones selected from said plurality of bubble release zones.

2. The water filtration system of claim 1 wherein each of said multiple bubble release zones has a diameter which is shorter than the separation distance between any two of said multiple bubble release zones.

3. The water filtration system of claims 1, further comprising at least one additional camera that, together with said first camera, is suitable to image each of said plurality of bubble release zones.

4. The water filtration system of claim 3, wherein more than one of said multiple bubble release zones is imaged by said at least one additional camera.

5. The water filtration system of claim 4, wherein all filtration elements within the pressure vessel correspond to a bubble release zone that is imaged by at least two cameras.

6. The water filtration system of claim 1 wherein said first camera is attached to a mount that extends into the vessel through a port on the vessel, said mount is removable from said vessel through said port, and said port has an inner dimension which would prevent removal of said filtration elements through said port.

7. The water filtration system of claim 6, wherein said mount comprises a seal surface suitable to create a water-tight seal with the vessel.

8. The water filtration system of claim 6, wherein said port is located on the side of said vessel.

9. The water filtration system of claim 1 wherein said first camera is located within the permeate chamber of the vessel.

10. The water filtration system of claim 6, where multiple cameras, including said first camera, are located within the permeate chamber of the vessel and attached to said mount, enabling said mount and said multiple cameras to be removed from the vessel through said port.

11. The water filtration system of claim 1 wherein the maximum outer diameter of elements is between 8% and 12% of the vessel inner diameter.

12. The water filtration system of claims 10, wherein a plurality of elongated probes each comprise a mount and multiple cameras, and said plurality of elongated probes are suitable to image bubble release regions located directly above each of said plurality of filtration elements.

13. The water filtration system of claim 1 comprising at least one camera with a field of view that is at least 4 times wider than it is tall.

14. The water filtration system of claim 1 wherein the system comprises at least one cylindrical lens.

15. The water filtration system of claim 1 wherein at least one camera is optically coupled to wide angle lens providing more than a 120° horizontal field of view.

16. The water filtration system of claim 3, wherein multiple cameras are located within two element diameters of the vessel wall.

17. The water filtration system of claim 1 wherein the cross-sectional area of each filtration element is at least five times larger than the cross-sectional area of a corresponding through hole in the pressure plate.
